(19) United States
(12) Patent Application Publication
(10) Pub. No.: US 2010/0030682 A1
(43) Pub. Date: Feb. 4, 2010

(54) PROCESSING DEVICE FOR NORMALIZING BARS REPRESENTATIVE OF WEIGHTED VARIABLE QUANTITIES

(76) Inventor: Wally Tzara, Le Plessis Robinson (FR)

Correspondence Address: CHRISTIE, PARKER & HALE, LLP, PO BOX 7068, PASADENA, CA, 91109-7068, US

(21) Appl. No.: 12/531,669

(22) PCT Filed: Mar. 13, 2008
(86) PCT No.: PCT/FR08/00328

§ 371 Date: Sep. 16, 2009

(30) Foreign Application Priority Data
Mar. 21, 2007 (FR) 0702060

(51) Int. Cl. G06Q 40/00; G06F 17/30

(52) U.S. Cl. 705/37; 707/104.1; 707/E17.044

(57) ABSTRACT

A device (DT) is dedicated to the processing of files of set(s) of data of events each consisting at least of a value taken at a given instant by a quantity that varies in time and of this given instant, as well as possibly of a weighting value, each set constituting a log of events for a given quantity. This device (DT) comprises processing means (MT) responsible for determining on the basis of a log of events of a quantity i) a total sum S of weighting values of the events of this log over part at least of a main period D defined between first and second chosen instants, then ii) the value of a normalization parameter defined by the operation S*(T/D′), where T is a time interval of chosen duration and D′ represents a sum of secondary periods constituting chosen sub-parts of the main period D and is expressed in a unit identical to the time interval T, then iii) a normalized chronological collection between the first and second chosen instants of grouping of events, termed normalized bars, whose weighting value is on each occasion equal to the value of the normalization parameter.

The invention relates to devices for processing files of sets of (digital) data of events, intended to be installed in computer equipment provided with at least one data processing microprocessor, such as a computer, optionally a portable computer, for example.

By the term “event” is meant here a set made up of at least one value assumed at a given instant by a quantity that varies over time and of the given instant, and optionally a weighting value (for example a weight or a derived weight). In addition, the term “log of events” used here refers to a set of events for a given quantity the value of which varies over time.

The invention relates to all types of quantities (or instruments) the value of which is likely to change over time and which may be the subject of weighting. For example, the events may be detections of physical quantities, such as showers of cosmic particles, each one defined by a total energy (value), an instant of occurrence and the number of cosmic particles contained in the shower (weight). In another example, the events may be trades (or “ticks”), for example financial (or stock exchange) quantities such as shares or forward contracts between buyers and sellers, each defined by a currency or price (value), a trading instant and a trading volume or traded number (weight); for example a tick (or event) is made up of 200 shares X traded at 17.5 euros at 09.20 hours on 10 March 2007, represented in compact form in the form of a multiplet of the type (10/03/2007, 09:20, 17.5, 200).

In certain fields, such as the financial sector for example (without being restrictive), it is common to weight data before analysing them using dedicated tools. This weighting is carried out on the basis of a set of events (e.g. ticks) relating to a given quantity (or instrument) and arranged chronologically between a first instant t1 and a second instant t2. Such a set constitutes a log of events (or tick log) of the quantity in question between the first instant t1 and second instant t2. A log of events usually takes the form of a data file in which each event (or tick) is an entry (set of digital data). For example, the event mentioned above and relating to the trading of 200 shares X is in the computer sense an entry comprising four fields, such as the date, time, price and volume.

These ticks relating to a given quantity are often chronologically grouped in different ways. The ticks thus grouped are frequently referred to as “bars”, in an incorrect use of language, as a reference to their general graphic representation. A bar may contain information such as for example the price of the first tick of the bar (referred to as “Open”), the price of the last tick of the bar (referred to as “Close”), the highest price of the ticks of the bar (referred to as “High” (or maximum price)), the lowest price of the ticks of the bar (referred to as “Low” (or minimum price)), the total volume of ticks in the bar (referred to as the volume of the bar) and the instant of the first tick (referred to as the bar instant). In the computer sense, a bar is an entry comprising a certain number of fields, such as for example the following six fields: date, time, Open, High, Low and Close). The multiplet (Oct. 3, 2007, 09:20, 17.5, 18.1, 17.2, 17.8) is a digital example of a bar shown in a compact form.

It will be noted that there are bars that do not contain all the data mentioned above. Thus, there are bars containing no information relating to volume, or bars containing derived information, such as for example mean values between the High and Low values. The multiplet (Oct. 3, 2007, 09:20, 17.65) is a digital example of a bar containing derived information (for example the mean value between High and Low) given in compact form.

Generally speaking, four types of bars are principally found:
bars corresponding to events (trades) that have occurred within a fixed time interval such as for example one minute, one hour or one day,
bars corresponding to a fixed total of events (trades) such as for example 10 or 200; these bars are known as “constant tick bars”,
bars corresponding to a fixed total of trade volumes, such as for example 500 shares traded; these bars are known as “constant volume bars”, and
bars corresponding to a fixed amplitude (the difference (High−Low) is a constant other than zero (0)), these bars are known as “constant amplitude bars”.

A set of bars of a certain type relating to a quantity (or instrument) constitutes a log (of bars) of said quantity relating to said type.

The bars relating to a quantity, such as for example the price of a share, may be represented graphically by a set of elements (or collection) made up of graphic symbols identified by equidistant abscissae. Normally, the instants (or time intervals) to which certain bars correspond are indicated as abscissae, for example every 10 bars. For example, an element of graphic representation of a bar comprises a segment defined between the High and the Low of said bar, optionally complemented by symbols indicating the Open and the Close. Other graphic representations of bars may be used, such as for example the so-called “candle” (or Japanese candlestick) and the so-called “curve” (dots usually joined together by a line segment).

In the following description, the word bar will be used interchangeably to denote a bar or its graphic representation.

By reason of the globalisation of the stock exchanges, the financial (stock) markets are open more and more continuously, not only during working hours (known as normal opening hours) during which the trades are often numerous, but also outside normal hours (thanks to electronic trading platforms such as the Globex, for example) during which trades are often rare (these times are known as extended opening hours).

Now, when bars of the first type are used (fixed duration), equal importance is given to each bar irrespective of its volume, so that the bars located in periods when trades are very rare count as much as bars located in periods where trades are very numerous, such as for example at the moment when the markets open. The technical indicators and digital calculations bearing on bars of this type, relating to an instrument, then suffer distortion which is all the more marked the greater the fluctuation in the trade volumes of this instrument.

When bars of the second type are used (constant tick bars), once again equal importance is given to each bar, irrespective of its trade volume (for example 5000 units traded or only 20). The distortion mentioned above is only partly eliminated.

When bars of the third type are used (constant volume bars), the duration of each bar is variable and depends on the trade volume per unit of time, which is referred to in the following description as “activity”. With this type of bar, the fact that account is taken of the trade volume and not of the number of trades makes it possible to reduce the period corresponding to the trades carried out during extended opening hours (Globex), as the trade volume is weaker on average for each trade. Consequently, the distortion mentioned earlier is prevented.

However, even though constant volume bars represent a grouping of financial data that is much more in conformity with the phenomenon constituted by the trades (which do not take place at a regular rate and at constant volume), they give rise to serious disadvantages which means that they are not very much used. These disadvantages include the fact that for each instrument (or quantity) the volume of its bars has to be regulated so that the set of bars in which one is interested falls within a range chosen in advance, for example about four hours, and the fact that for the same instrument (or quantity) the volume of its bars has to be adjusted regularly in order to maintain a range equivalent to that which was chosen initially. When the user is following a large number of instruments (or quantities), for example 100 (which is relatively common), the time spent in making these adjustments at regular intervals becomes considerable, as they have to be done for each instrument.

When bars of the fourth type are used (constant amplitude bars), it is not possible to control either the time factor or the activity, which means that the technical indicators and digital calculations no longer make sense.

The invention therefore sets out to remedy this situation.

To this end it proposes a device for processing files of set(s) of (digital) data of events each consisting at least of the value assumed at a given instant by a quantity that varies over time and of this given instant, as well as possibly a weighting value (for example a weight or a derived weight), each set constituting a log of events for a given quantity.

This processing device is characterised in that it comprises processing means tasked with determining on the basis of a log of events of a quantity:
the total sum S of weighting values of the events of this log over at least part of a main period D defined between first (t1) and second (t2) chosen instants, then
the value of a normalization parameter X defined by the operation S*(T/D′), where T is a time interval of chosen duration and D′ represents a sum of secondary periods constituting chosen sub-parts of the main period D and is expressed in a unit identical to the time interval T, then
a normalized chronological collection between the first and second chosen instants of groupings of events, termed normalized bars, of the log of events whose weighting value is on each occasion equal to the value of the normalization parameter X.

It is important to note that when the set which defines an event does not contain a weighting value, the processing device DT may optionally be tasked with adding to this set a weighting value equal to one (1). Moreover, when the set which defines an event contains a weighting value such as a weight, the processing device DT may optionally either use this weight to determine the sum total S, or be tasked with replacing this weight by a weighting value equal to one (1), or again tasked with replacing this weight by a weighting value equal to a derived (or auxiliary) weight.

The processing device according to the invention may have other features that may be taken separately or in combination, notably:
its processing means may be tasked with determining normalised chronological collections for sums D′ of (a) main period(s) D which is (are) prior to the first instant chosen and/or subsequent to the second instant chosen, in order to constitute a log of normalised bars relating to the quantity in question;
its processing means may be tasked with assigning to each event of the log of events a weighting value equal to one (1) so as to determine a sum total S equal to the total number of events over at least part of this log of events. The normalisation parameter is then a normalised number of events;
its processing means may be tasked with determining a sum total S of the weighting values of the events of the log over the entire main period D or over part of the main period D equal to the sum of the secondary periods D′;
the quantity may be for example a share the value of which for each event, known as a trade, is that of its price at the instant of the trade and the eventual weighting value of which is the number of securities traded at the said instant. Each trade thus relates to a given number of shares at a given price. In a variant, the quantity may be for example a chosen forward contract the value of which, for each event, known as a trade, is that of its price at the instant of the trade, and the eventual weighting value of which is the number of contracts traded at the said instant. Each trade thus relates to a given number of forward contracts at a given price;
its processing means may be tasked with determining the sum D′ of secondary periods which constitute either phases of normal opening and/or extended opening (Globex) of a financial market (stock market) over a chosen main period D, or only phases of normal opening of a financial market over a chosen main period D;
its processing means may be tasked, when a new normalised chronological collection has to be calculated for a new period subsequent to the second instant but of shorter duration than the main period D, with determining this new normalised chronological collection, using the value of the normalisation parameter determined for this main period D defined between the first and second instants chosen;
its processing means may for example be tasked with using a time interval T which is equal either to a chosen whole multiple of a minute, or to the result of dividing a chosen divisor of the number 60 by this number 60;
its processing means may for example be tasked with using a main period D which is a chosen whole multiple of either a week or a month;
it may comprise memory means tasked with storing the data that define at least one of the normalised chronological collections of at least one quantity and/or at least one log of normalised bars relating to at least one quantity.

The invention also proposes a storage medium intended to be connected to computer equipment and storing at least part of a processing device of the type described hereinbefore and arranged in the form of a program or programs.

Further features and advantages of the invention will become apparent from a study of the detailed description that follows, and the attached drawings, wherein:

FIG. 1 shows in highly schematic and functional form an embodiment of a processing device according to the invention installed in computer equipment,

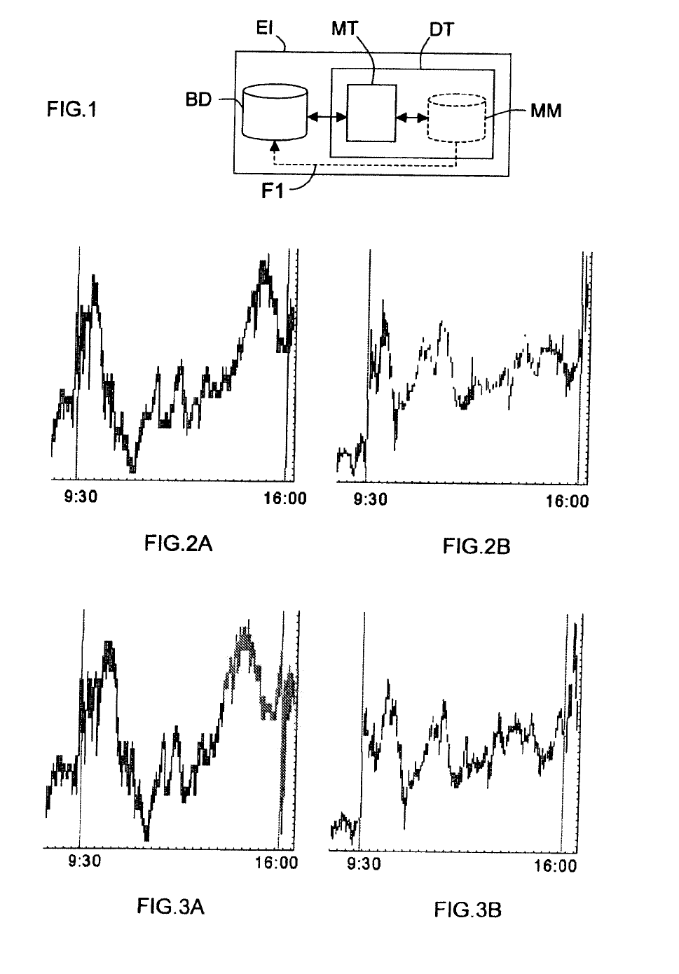

FIGS. 2A and 2B schematically illustrate two examples of logs of bars relating respectively to the prices of two different shares during the same part of a day,

FIGS. 3A and 3B schematically illustrate two examples of normalised chronological collections constructed using a processing device according to the invention from tick logs which have been used to draw the graphs in FIGS. 2A and 2B, respectively,

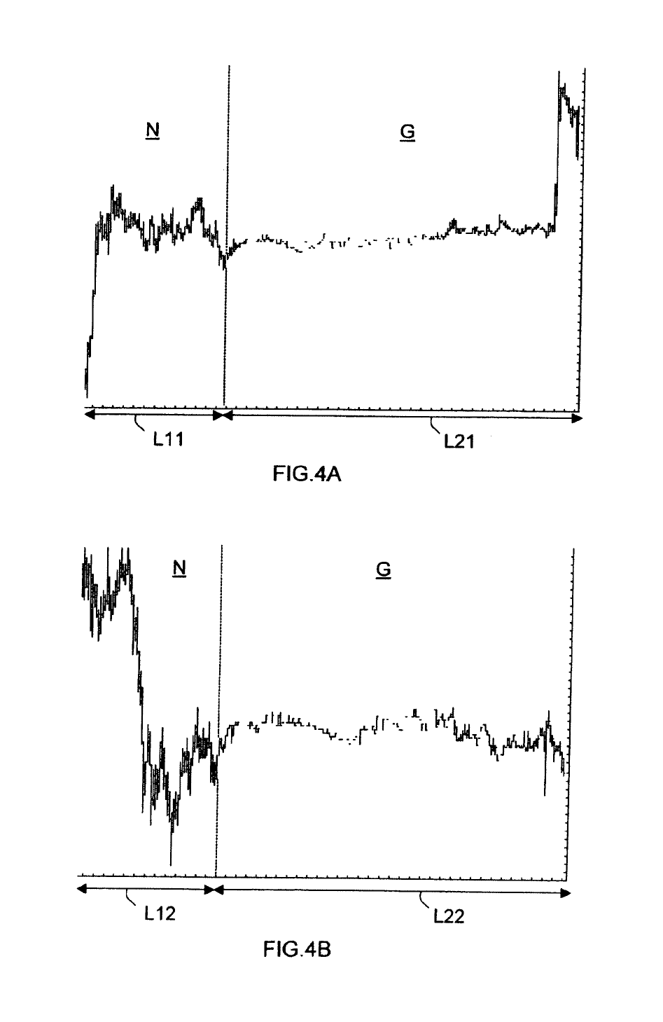

FIGS. 4A and 4B schematically illustrate two examples of bar logs relating to the price of the same financial index during first and second days, respectively, and

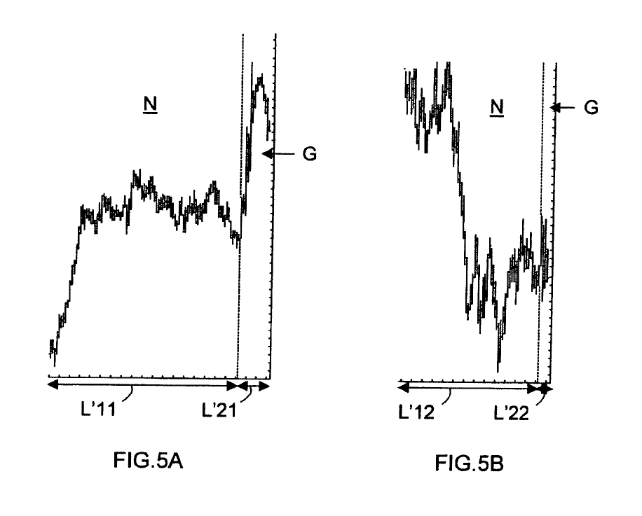

FIGS. 5A and 5B schematically show two examples of normalised chronological collections constructed using a processing device according to the invention from tick logs which have been used to draw the graphs in FIGS. 4A and 4B, respectively.

The attached drawings may serve not only to complete the invention but may possibly also contribute to its definition.

The invention sets out to allow a user to obtain chronological collections of normalised bars and logs of normalised bars relating to quantities that are variable over time, by means of a device for processing files of set(s) of data of events relating to these quantities.

In the description that follows, it is assumed, as a non-restrictive example, that the quantities to be processed are share prices or financial indices. Consequently, the events are share trades (or “ticks”) between buyers and sellers, each defined by a price (value), a trading instant and a trading volume or traded number (weighting value (equal to a weight in this case)). However, the invention relates to any kind of quantity the value of which is likely to develop over time and which may be the subject of weighting. Thus, the events may also (without being restricted thereto) be detections of physical quantities such as showers of cosmic particles each defined by a total energy, an instant of occurrence and the number of cosmic particles contained in the shower.

Reference will be made first to FIG. 1 to show an embodiment of a processing device DT according to the invention. A device DT of this kind is intended to be installed in computer equipment EI provided with at least one data processing microprocessor, storage media and a man/machine interface (keyboard, mouse and the like). This computer equipment EI may for example be a (micro-)computer, optionally a portable (or mobile) (micro-)computer, or a workstation.

This processing device DT is preferably constructed in the form of software modules. However, it may also be in the form of electronic circuits (or “hardware”) or a combination of circuits and software.

When the device DT is constructed in the form of software modules, it may for example be installed in the computer equipment EI by downloading via a server or by loading from a storage medium such as an optically readable disc (CD-ROM or DVD-ROM), a magneto-optical disc or a USB key on which it is stored.

The processing device DT comprises at least one processing module MT tasked with processing files of set(s) of (digital) data of events (in this case trades). When the device DT is constructed in the form of software modules, its processing module MT is loaded into the computer equipment in order to be used by its processor(s).

The files of set(s) of data are stored for example in a memory or a database BD which is part of the computer equipment EI (as in the non-restrictive embodiment shown in FIG. 1) or which is part of an add-on memory connected to this computer equipment EI (such as for example a USB key) or which is part of other computer equipment that can be accessed by said computer equipment EI through a communications network.

It will be noted that each set constitutes a log of events (in this case trades) for a given quantity (for example the movement of a share or of a financial index) over a given period (for example a day, a week or a month). Each log of events can be displayed on the screen of computer equipment in the form of a graph that shows the development over time of “bars” (in the sense defined in the introduction) relating to a quantity.

FIGS. 2A and 2B show two examples of logs of trades relating respectively to the prices of two different shares Y and Z during the same part of a day (in this case between about 08.45 and 16.15). The times 09.30 and 16.00 shown on the time axis of the coordinates designate the normal opening time and normal closing time of a market, respectively. Here, the time interval between two graduations on the time axis of the coordinates represents 15 minutes and each bar corresponds to trades in shares Y or Z over a period of 3 minutes.

When the device DT receives a file of a set constituting the log of events of a given quantity, its processing module MT starts by determining the sum total S of weighting values of the events in this log over at least part of a main period D which is defined between selected first t1 and second t2 instants.

It will be noted that when the set of digital data that defines an event does not contain a weighting value, the processing device DT may be tasked with adding to this set a weighting value equal to one (1). This addition may. In an alternative embodiment, the processing device may assign to each event a weighting value equal to one (1). Moreover, when the set of digital data defining an event contains a weighting value such as a weight, the processing device DT may either use this weight to determine the sum total S, or be tasked with replacing this weight with a weighting value equal to one (1), or be tasked with replacing this weight with a weighting value equal to a derived (or auxiliary) weight. In another embodiment, the processing device DT may assign to each event another weighting value equal to one (1) or assign another weighting value equal to a derived (or auxiliary) weight.

It will be noted that the sum total S is determined from weighting values of events such as weights or derived weights.

It will also be noted that, depending on the requirements, the processing means MT may determine either a sum total S over the entire main period D, or over a sum D′ of secondary periods which constitute selected (time) sub-parts of the main period D.

The sum D′ of secondary periods is expressed in the same unit as that of a time interval T of selected duration which will constitute the constant average duration of future normalised bars. This sum D′ corresponds for example to the accumulated duration of the opening phases of the market to which the quantity in question belongs during the main period D. However, it may also correspond to the sum of the normal opening periods and the extended opening periods outside normal hours (known as Globex), or even to the main period D. It may also correspond to a selected fraction of the normal opening hours and/or the extended opening hours (Globex). It may also be an approximation of the sums of the normal opening periods and/or the extended opening periods.

It will be noted that D′ can be determined from knowing the opening times of the markets (normal, extended (Globex), holidays and the like) or from an analysis of the logs of events. For example, the sum D′ may be determined by constituting over the main period D groups of events of fixed duration (fixed duration bars), for example of 15 minutes, then totalling the number of fixed duration bars. The value selected for D′ is then equal to the product of the number of said bars comprising at least one event by said duration.

The processing module MT may use any time interval T. However, it is preferable for this time interval T to be equal to a selected whole multiple of a minute (for example 1 minute or 5 minutes), or to the result of dividing a selected divisor of the number 60 by this number 60 (for example half a minute (or 30 seconds) or a third of a minute (or 20 seconds)).

Moreover, the processing module MT can use any main period D. However, it is preferable for this main period D to be equal to a selected whole multiple of a week or month.

By way of example, looking at a main period D equal to a calendar week, a market open 5 days a week with normal opening hours between 08.00 and 18.00 (i.e. 10 hours), and a time interval T of 5 minutes, the sum D′ of the opening phases during the main period D is equal to 3000 minutes (5 (days)*10 (hours)*60 (minutes)=3000).

Once the sum total S has been determined (over the main period D or over the sum D′), the processing module MT determines the value of a normalisation parameter X which is defined by the operation S*(T/D′). For example, taking the values of the example mentioned above and if the sum total S of the weighting values (in this case the weights) of the trades in the log over the sum D′ is equal to 1531927, a whole (rounded) value of the normalisation parameter X is obtained which is equal to 2553 (1531927(S)*(5 (T)/3000 (D′))=2553.21). In this case the normalisation parameter X is a normalised trading volume intended to fix the (constant) trade volume of each bar that is to be normalised.

It is important to note that instead of determining a normalisation parameter X representing a normalised exchange volume, it is possible to determine a normalisation parameter X representing a normalised number of trades.

To do this, the processing module MT has to assign to each trade in the log of events a weighting value equal to one (1), then it determines the sum total S (over the main period D or over the total D′) which in this case becomes equal to the total number of trades N in this log of events. The operation defining the normalisation parameter X can thus be rewritten N*(T/D′).

It is also important to note that instead of determining a normalisation parameter X representing a normalised trade volume, it is possible to determine a normalisation parameter X representing a derived normalised trade volume.

In order to do this, the processing module MT has to analyse the trades in the log of events in order to assign to them weighting values (or derived weights or auxiliary weights) representing the fact that their respective trade volumes belong to chosen intervals. For example, a trade (or tick) with a volume of less than 10 may count for a volume of 1, a tick with a volume of between 10 and 100 may count for a volume of 2, a tick with a volume between 100 and 1000 may count for a volume of 3, and so on. These new auxiliary volumes are then used instead of the initial volumes.

Once this assignment has been done, the processing module MT determines the sum total S (over the main period D or over the total D′), which in this case becomes equal to the sum M of the auxiliary (or derived) weights (or volumes) of the trades in the log of events. The operation defining the normalisation parameter X can thus be rewritten M*(T/D′).

When the processing module MT has a value for the normalisation parameter X (representing a normalised trade volume, a normalised number of trades or a derived normalised trade volume), it determines a normalised chronological collection between the first t1 and second t2 instants chosen (which define the main period D), of groups of events, known as normalised bars.

It is important to note that the weighting value of each normalised bar is constant and equal to the value of the normalisation parameter X. Consequently, the type of normalised bars in a normalised chronological collection depends on the type of normalisation parameter X used to determine it. For example, if the normalisation parameter X represents a normalised trade volume, then each normalised bar in the normalised chronological collection has not only a constant volume but also a constant average duration equal to the time interval T. If the normalisation parameter X represents a normalised number of trades, then each normalised bar in the normalised chronological collection not only has a constant number of ticks but also a constant average duration equal to the time interval T. If the normalisation parameter X represents a derived normalised trade volume, then each normalised bar in the normalised chronological collection not only has a constant derived volume but also a constant average duration equal to the time interval T.

It will be noted that the processing module MT may use any technique known to the skilled man to constitute a normalised chronological collection from a log of events and a corresponding normalisation parameter X. For example, such a technique may consist in aggregating the ticks in order to construct the normalised bars step by step, i.e. move on to the next bar when the weighting value of the normalised bar formed equals X, where Open is the value of the first aggregated tick, High is the highest value of the set of aggregated ticks, Low is the lowest value of the set of aggregated ticks, and Close is the value of the last aggregated tick.

FIGS. 3A and 3B graphically show two examples of normalised chronological collections relating respectively to the movements of the two shares Y and Z illustrated in FIGS. 2A and 2B. Here, the normalisation parameter X represents a normalised trade volume. Moreover, these examples correspond to volumes of trade in shares Y and Z equal to 35410252 and 356596, respectively, over a main period D equal to one week, a time interval equal to 3 minutes and a sum D′ of opening phases during the main period D equal to 5 days open for 6 and a half hours (i.e. 1950 minutes). With these values, the respective values of the normalised trade volumes per normalised bar of three minutes (T=3) are equal to 54477 and 549, respectively, for the shares Y and Z.

As the two shares belong to the same market, they are represented in FIGS. 3A and 3B in respective time spans that are more or less identical to the time span used on the graphs in FIGS. 2A and 2B.

FIGS. 4A and 4B also graphically represent two examples of logs of trades relating to the movement of the same instrument (for example the forward contract of the NASDAQ index) during first and second days, respectively. Here, each bar corresponds to a time interval T of 7 minutes. The reference N indicates the period of normal opening during the day, while the reference G indicates the period of the day that is outside normal hours (extended opening hours or Globex). Moreover, the references L11 and L21 respectively designate the time spans of the periods N and G for the first day, while the references L12 and L22 respectively designate the time spans of the periods N and G for the second day. The lengths of the arrows L11, L21, L12 and L22 (like those of the arrows L′11, L′21, L′12 and L′22 of FIGS. 5A and 5B) provide information as to the number of bars relating to the respective time spans.

As the opening hours are the same on the two days in question, the lengths of the arrows L11 and L12, on the one hand, and of the arrows L21 and L22, on the other and, are the same.

With the type of bar chosen (fixed duration), it will be seen by comparing the length of L21 (or L22, respectively) in relation to that of L11 (or L12, respectively) that the period G with a low trade volume (Globex) is over-represented, as confirmed by the low amplitude of the bars. To overcome this disadvantage, the method described hereinbefore is applied to the logs of events in FIGS. 4A and 4B.

FIGS. 5A and 5B illustrate the graphic representations of two examples of normalised chronological collections built up using a processing device DT from the graphs in FIGS. 4A and 4B, respectively. Here, each normalised bar also corresponds to a time interval T equal to 7 minutes. In addition, by way of example, it was decided to average out the volumes during normal opening hours only and over the last four weeks that have elapsed (D=4 weeks). The total trade volume A in this example is calculated over the main period D and is equal to 5137886 contracts. As the market is normally open from 09.30 to 16.15, the total D′ is equal for example to 8100 minutes (4 (weeks)×5 (days)×6.75 (hours)×60 (minutes)=8100). Consequently, taking T to be equal to 7 minutes, a normalised trade volume X of 4440 is obtained (5137886×(7/8100)=4440).

The normalised bars of the graphs in FIGS. 5A and 5B therefore all have the same normalised trade volume (equal to 4440) and the same average duration T (equal to 7 minutes).

As can be observed, thanks to the normalised bars according to the invention, the trade volume during the normal period N of the first day (FIG. 5A) is greater than the daily average, as indicated by the ratio between the length of the arrow L′ 11 in FIG. 5A and the length of the arrow L11 in FIG. 4A (or L12 in FIG. 4B)), whereas that of the second day (FIG. 5B) is roughly equal to said daily average, as indicated by the ratio between the length of the arrow L′12 in FIG. 5B and the length of the arrow L11 in FIG. 4A (or L12 in FIG. 4B).

The processing module MT may for example store the normalised chronological collection which it has determined in memory means MM which may form part of its device DT (as illustrated in a non-restrictive capacity) or of the computer equipment SI or in the database BD of the computer equipment EI or in the storage medium if it is of the rewritable kind. These memory means MM may take any desired form, such as for example a memory or a database.

When the device DT is constructed in the form of software modules, its processing module MT is loaded into the computer equipment in order to be used by its processor or processors.

Moreover, when the processing module MT has determined at least two normalised chronological collections relating to the same quantity and for consecutive main periods D (one being between t1 and t2, the other between t2 and t3 (where t2−t1=t3−t2), or one being between t0 and t1, the other between t1 and t2 (with t1−t0=t2−t1)), it may then form a log of normalised bars relating to this quantity.

The processing module MT may for example store the log of normalised bars which it has determined in the above-mentioned memory means MM. It can also use the memory or the database BD to store the log of normalised bars (as indicated in FIG. 1 by the dotted arrow F1).

Furthermore, when the processing module MT has a log of normalised bars up to a given instant t and a collection of ticks subsequent to this instant t, which is insufficient to form a new normalised chronological collection (i.e. over a period of time less than the main period D), it may be arranged so as to use, as the value of the normalisation parameter X, the value relating to the normalised chronological collection ending at the instant t.

For example, let us suppose that it is a Wednesday and that the normalised log relating to an instrument up to the previous Friday is available and that the main period D chosen is a week (defined as running from Saturday morning to the following Friday evening), the processing module MT can determine new normalised bars (for example with a normalised trade volume) by using the value of the normalisation parameter X relating to the week that ended on the previous Friday.

It should be noted that the new normalised chronological collection thus obtained is not normalised correctly (in the sense of the definition provided hereinbefore) as the sum total S used does not correspond to the trades taken into account to form it. If this collection is to be normalised correctly, it is essential to wait for the corresponding collection of events to cover the main period D completely, in order to make it possible to calculate the value of the normalisation parameter X relating to said collection of events and thus form a new normalised chronological collection which can then optionally complete the existing normalised log.

It will be noted that it is useful, when the main period D chosen is a week or multiple weeks, to stop the totalling period D′ of an instrument on the last closure of the market or on the last weekly closure, generally the Friday, as this makes it possible to calculate the sum total S relating to said instrument during the period of closure of the market when the computers are not overloaded.

It will also be noted that the invention may advantageously make it possible to reduce the load on the computer equipment EI (in terms of computing time) and the volume of data stored.

To do this, the device DT is used to constitute at least some of the instruments (or quantities), for example shares, from their respective complete logs of events (in ticks), their normalised bar logs as described hereinbefore, but using a low value as the time interval T.

The time interval T currently regarded as being the most convenient is one minute, as it corresponds to the shortest time interval generally used. However, it is also possible to use a shorter time interval, for example 15 seconds (0.25 minutes), or a longer time interval, for example 2 minutes.

Once a log of normalised bars has thus been produced for a given quantity, the processing module MT can thus reconstruct, on demand, any normalised chronological collection or any log of normalised bars for this given quantity using a time interval T′ which is a multiple of T.

For example, if the intention is to obtain a log of normalised bars based on an interval of 60 minutes and if a complete log of normalised bars based on an interval of 30 seconds (half a minute) is available, all that is required is to aggregate 120 consecutive normalised bars of this last log to form a normalised bar of the desired new log. This operation of aggregating normalised bars is exactly the same as the one used to move from a log in minutes to a log in a any desired whole number of minutes, which is well known to the skilled man.

It will therefore be understood that if one is interested only in representations in normalised bars, there is no longer any need to store the log of events relating to a quantity; storing the log of normalised bars of this quantity is sufficient. This results in a considerable saving in storage space. For example, taking the forward contract of the NASDAQ index for the year 2006, its log of events (in ticks) in the CSV format represents about 82 KB whereas its log of normalised bars represents about 5 KB for a time interval T of one minute.

Moreover, as it is possible to calculate the number of normalised bars contained in a given time interval, it is possible to tell in advance, with precision, the storage volume necessary for an entire database made up of numerous instruments (or quantities).

Furthermore, as it is no longer necessary to reconstitute the normalised chronological collection or the log of normalised bars of an instrument (or quantity) each time someone is interested in this instrument, the load on the computer equipment in terms of computing time is reduced substantially.

The invention is not limited to the embodiments of the processing device, storage medium and computer equipment described hereinbefore, purely by way of example, but encompasses all the alternatives that may be envisaged by the skilled man within the scope of the claims that follow.

1. Device (DT) for processing files of set(s) of data of events each consisting at least of the value assumed at a given instant by a quantity that varies over time and of this given instant, as well as possibly a weighting value, each set constituting a log of events for a given quantity, characterised in that it comprises processing means (MT) arranged so as to determine on the basis of a log of events of a quantity i) a total sum S of weighting values of the events of this log over at least part of a main period D defined between first (t1) and second (t2) chosen instants, then ii) the value of a normalization parameter (X) defined by the operation S*(T/D′), where T is a time interval T of chosen duration and D′ represents a sum of secondary periods constituting chosen sub-parts of said main period D and is expressed in a unit identical to the time interval T, then iii) a normalized chronological collection between said first (t1) and second (t2) chosen instants of groupings of events, termed normalized bars, of said log of events whose weighting value is on each occasion equal to said value of the normalization parameter (X).

2. Device according to claim 1, characterised in that said processing means (MT) are arranged so as to determine normalised chronological collections for totals D′ of (a) main period(s) D which is (are) prior to the first instant chosen (t1) and/or subsequent to the second instant chosen (t2), in order to constitute a log of normalised bars relating to the quantity in question.

3. Device according to claim 1, characterised in that the said processing means (MT) are arranged so as to assign to each event of said log of events a weighting value equal to one (1), so as to determine a sum total S equal to the total number of events over at least part of said main period D of said log of events, the normalisation parameter then being a normalised number of trades.

4. Device according to claim 1, characterised in that the said processing means (MT) are arranged so as to determine a sum total S of the weighting values of the events of the log over the entire main period D.

5. Device according to claim 1, characterised in that the said processing means (MT) are arranged so as to determine a sum total S of the weighting values of the events of the log over part of said main period D equal to said sum of the secondary periods D′.

6. Device according to claim 1, characterised in that the said quantity is a share the value of which for each event, known as a trade, is that of its price at the instant of the trade and the eventual weighting value of which is the number of securities traded at the said instant.

7. Device according to claim 1, characterised in that the said quantity is a chosen forward contract the value of which, for each event, known as a trade, is that of its price at the instant of the trade, and the eventual weighting value of which is the number of contracts traded at the said instant.

8. Device according to claim 1, characterised in that the said processing means (MT) are arranged so as to determine a sum D′ of secondary periods which constitute phases of normal opening and/or extended opening of a financial market over a chosen main period D.

9. Device according to claim 1, characterised in that the said processing means (MT) are arranged so as to give the sum D′ a value corresponding to an approximation of the sums of the periods of normal opening and/or the periods of extended opening of a financial market over a chosen main period D.

10. Device according to claim 1, characterised in that the said processing means (MT) are arranged, when a new normalised chronological collection has to be calculated for a new period subsequent to the second instant (t2) but of shorter duration than the main period D, so as to determine this new normalised chronological collection, using the value of the normalisation parameter (X) determined for said main period D defined between said first (t1) and second (t2) instants chosen.

11. Device according to claim 1, characterised in that the said processing means (MT) are arranged so as to use a time interval T which is equal either to a chosen whole multiple of a minute, or to the result of dividing a chosen divisor of the number 60 by said number 60.

12. Device according to claim 1, characterised in that the said processing means (MT) are arranged so as to use a main period D which is a chosen whole multiple of either a week or a month.

13. Device according to claim 1, characterised in that it comprises memory means (MM) arranged so as to store data that define at least one of the normalised chronological collections of at least one quantity and/or at least one log of normalised bars relating to at least one quantity.

14. Storage medium for data files defining programs for computer equipment (EI), characterised in that it stores at least part of a processing device (DT) according to claim 1, arranged in the form of programs.
